(19) United States
(12) Patent Application Publication
(10) Pub. No.: US 2009/0294253 A1
(43) Pub. Date: Dec. 3, 2009

(54) Apparatus and method for diverting in a conveying system

(76) Inventors: Howard Eisenberg, Woodbine, MD (US); Edward Hrehocik, Baltimore, MD (US)

Correspondence Address: WILEY REIN LLP, 1776 K. STREET N.W., WASHINGTON, DC, 20006, US

(21) Appl. No.: 12/457,122

(22) Filed: Jun. 1, 2009

Related U.S. Application Data
(60) Provisional application No. 61/057,591, filed on May 30, 2008.

(51) Int. Cl. B65G 47/74

(52) U.S. Cl. 198/601

(57) ABSTRACT

The invention relates to an apparatus and method for diverting the path of container units or other articles from an initial conveying direction in a conveying system. In a preferred example, the conveying system incorporates a hinged divert section along a conveying path to more efficiently and robustly divert a container or article in one of several directions, preferably perpendicular to the initial conveying direction. The invention is particularly useful in package processing and storage applications. The hinged divert section of the invention operates using a mechanically advantageous hinged or tilting surface that requires less energy or force to engage a container transport element. Multiple vertical levels can be employed within the conveying system, with the hinged divert section moving vertically and transporting containers in different directions and/or different levels within the conveying system.

### RELATED APPLICATION

This application claims the benefit of U.S. Provisional Application No. 61/057,591, filed May 30, 2008, which is hereby incorporated by reference as though fully set forth herein.

### FIELD OF THE INVENTION AND INTRODUCTION

The invention relates to an apparatus and method for diverting the path of units on a conveying system. In a preferred example, the conveying system incorporates a hinged divert section along a conveying path to more efficiently and robustly divert a container or article in one of several directions. The invention is particularly useful in package processing and storage applications. The hinged divert section of the invention operates using a mechanically advantageous hinged or tilting surface that requires less energy or force to engage and therefore is more reliable over time and cheaper to operate. In addition, the hinged divert section accurately moves the package or container in a desired direction.

### RELEVANCE AND BACKGROUND TO THE INVENTION

The processing, sorting and delivering performed in storage or delivery operations have undergone considerable automation in the last decade. Certain aspects are in need of further innovation. Typically, right angle divert systems include lift devices that effectively raise the entire weight of a package or container in order change directions or further process along a conveying path. Requirements for many commercial and industrial high volume systems include several hundreds of thousands of cycles for an average lifetime and many hundreds per 24-hour period. To accommodate these requirements, current right angle divert systems employ heavy mechanical lifting devices that require considerable energy, are prone to break, and are expensive. Alternatives to these lifting means could reduce costs and servicing time.

### SUMMARY OF THE INVENTION

In a general aspect, the invention encompasses a device, apparatus, or method for accurately diverting objects on a conveying surface to one of several possible directions. Any of a variety of containers, trays, totes, cartons, boxes, parcels, or containers can be used. The concepts and aspects of the invention described here can be used in many storage, processing, delivery, and other systems, or wherever a conveyor is used.

As used herein, divert or diverting is a term referring to a process to move (temporarily or permanently) an object from the flow of a main conveyor. The direction the object is moved can be any desired and optionally is one of two right angle divert directions possible, a 180 degree divert or a continuation in substantially the same direction as the main conveyor, or even a 360 degree divert in the opposite direction of the main conveyor. Other angled diverts are possible. As explained more fully below, the divert function is accomplished with a divert section incorporated into a conveyor path. The divert section can also move vertically to transfer itself and the article or container on it to a different conveyor level, either up or down, and then divert the container to any desired direction. Multiple divert sections can be used in a conveyor system to manipulate a container into a desired storage site, or move a desired container from a storage site to another site. In a preferred embodiment, the divert section is used to move a container from a first conveyor direction to a second conveyor direction, where the second conveyor direction can be at an angle to the first direction or even be on a separate vertical level to the level of the first direction.

In a particular aspect, the invention may be used in a conveying system comprising a first conveyor having a first conveying surface along which an article may be conveyed in a first direction and comprising a second conveyor having a second conveying surface along which an article may be conveyed in a second direction, where the first and second directions may be any desired directions. A hinged divert section operably connects the first conveyor and the second conveyor, where the hinged divert section comprises a frame and at least a first and second transport element. The first transport element is oriented to allow movement of an article on the first conveying surface. The second transport element is oriented to allow movement of an article on the second conveying surface. The first and second transport elements can be used to divert an article in one of several directions, including at right angles to the loading or initial direction, 180 degrees or 360 degrees to the initial or loading direction. A tray can support the first transport element, the tray being pivotally connected to the frame such that the tray is movable between a first position, wherein an article on the first conveying surface contacts only the first transport element, and a second position, wherein an article on the first conveying surface contacts only a second transport element. Thus, engaging movement from the pivot or hinge point can divert the article in one of many directions. A second tray can support the second transport element, which can be in a fixed position on the frame or can be moveable relative to the tray of the first transport element or moveable relative to the frame. In some embodiments, one or more transport elements are motorized belt or roller systems. In other embodiments, the second direction is substantially perpendicular or at a right angle to the first or loading direction.

The hinged divert section can be designed in many different ways to accommodate a lowering or raising of a transport element in order to contact the article being conveyed and divert it off of the hinged divert section. In one design, a tray element moves on a hinge or pivot point or pivots points. Thus, the tray can be moved between a first position and at least a second position by the action of a motorized piston or pneumatic device contacting the tray. In other embodiments, rollers, belts, pushers, or other transport elements can themselves be linked to a hinge or one or more pivot points and then moved into contact or to substantially avoid contact with an article or container resting on the divert section. Thus, while the tray example is shown specifically in the drawings as a way of moving the transport elements to engage or disengage from a transport position, a tray to contain the transport element(s) is not specifically required.

As discussed, the invention can also comprise a vertical transport element for movement of the hinged divert section from a first vertical level to a second vertical level. Generally, the second transport level can operably be connected to the second vertical level so that an article or container can be moved from first to second level while being conveyed to a desired position.

In another aspect, the invention involves a conveying system comprising a first conveyor having a first conveying surface and a second conveyor having a second conveying surface, where the first and second surfaces are operably connected by a hinged divert section as defined by one of the many embodiments discussed here. The hinged divert section is also referred to as a pivoting divert section or a multi-directional hinged divert section, and in any case the mechanical advantages of using a fulcrum to assist the movement of one or more transport elements to engage an article or container on the surface is present. The terms article and container are generically representative of any unit or object that can be conveyed on a conventional conveying system. The terms article and container may be used interchangeably in this document. In optional embodiments, the divert section comprises a first tray supporting a first transport element and a second tray supporting a second transport element, wherein the first tray and the second tray are movable relative to each other. The movement is designed to alternate between a first configuration and at least a second configuration. In the first configuration, an article moving through the conveying system contacts only the first transport element at a desired time and is thereby conveyed along the first conveying surface. In the second configuration, an article moving through the conveying system contacts only the second transport element at a desired time and is conveyed along the second conveying surface. Generally, the first and second conveying surfaces are in different directions, preferably at right angles or substantially perpendicular to each other, but they need not be. In one option, the first and second tray are moveable relative to each other by a hinged connection of the first or second tray to a stationary frame or part of the frame of the divert section. The transport elements selected can be the same or different for the first and second or more transport elements used. Typical transport elements include a motorized belt, a motorized roller, combinations of belts and rollers, or a pusher device. In a preferred embodiment, the first or second tray is moveable between a first position and a second position by the action of a motorized piston or a pneumatic device. As in any of the embodiments of the invention, this embodiment can also incorporate one or more vertical transport elements for movement of the divert section from a first vertical level to a second vertical level.

In general, the conveying process is computer controlled through indicators, tags, or labels on each article or tray, as known in the art. Bar code labels are especially useful for this purpose and can be detected by electro-optic or other industrial optic devices known in the art. Known or available computer control systems can be incorporated into the invention. The invention can also be used with guides or other devices to maintain an article or container on a preferred area of the conveying surface.

In aspects of the invention where an article is moved from one position to a second position, the transport element of the hinged divert section preferably is in continuous conveying connection with a conveyor axis or path. The contact with the article when the transport element(s) is/are engaged should be at an adequate force level to make the transport element capable of pushing or maneuvering the article in the desired direction. Ideally, it should be calibrated to avoid tilting, skewing, or falls off the conveyor surface or the divert section surface. The point of contact, or points of contact, between the divert section transport element(s) and the article can also be adjusted and calibrated. In addition, the position of the article can be monitored so that the main, initial, or second conveyor resumes conveying articles along an axis or path only after an article is free of the hinged divert section. A preferred embodiment will be calibrated and adapted to convey, sort, deliver, or divert containers of a particular weight range, and the piston, pump, or mechanical device used to raise or lower the trays or transport elements are selected accordingly. When the transport element(s) of the hinged divert section is activated and/or engaged, generally through a computer controlled detection process, the conveyor stops the article at the divert section, the transport element(s) are engaged, for example by activating a piston or motor to push or release a tray connected to the transport element(s) so that the transport element(s) contact the article, and the article is moved off of the hinged divert section in any desired direction. The tray and transport element(s) are then moved back to the original or disengaged position. As noted above, guides on the side of the conveyor may be used to assist in ideal placement of the article, and the guides may be moveable from a position where they can contact or control the article to a position where they cannot. Throughout this disclosure, we refer to an initial or main or first conveyor, conveyor surface, a conveyor axis, or conveyor path as essentially the same thing, the direction that objects are being moved over a conveying function of the system. However, various points along the main conveyor path may be physically part of the main conveyor or part of a hinged divert section of the invention. Preferred examples include a main conveyor having a plurality of rollers for moving containers along a conveying axis or path that is formed by the conveyor rollers and include one or more multi-directional hinged divert sections capable of being combined or linked with the conveying axis or path and the rollers of the axis or path. The multi-directional hinged divert sections can be configured to have only three, or two directions different from the initial or main conveyor path. The conveyor system as a whole, or a method of conveying articles, can be operated with a plurality of multi-directional hinged divert sections. The conveyor system, method or device can also employ photoelectric sensor(s) to detect the position of an article on the conveyor axis or path or anywhere on the conveyor system. Any one of many available detection technologies and/or sensor technologies can be selected and adapted for use.

In addition, the conveyor system, method or device can be used in conjunction with a master control computer to monitor the movement of articles, to determine whether an article contains an ID or sort label for a desired divert or storage area, and/or detect incorrect sorting or other errors in the conveying process. One of skill in the art is familiar with many available computer systems, software, and master control computers that can be selected and adapted for use with the invention. Generally, the master control computer controls the motors for rollers or surfaces of the main conveyor as well as the belts, rollers, surfaces, and divert sections for the multi-directional hinged divert operations.

### BRIEF DESCRIPTION OF THE FIGURES

The invention can be more clearly shown by the examples of the figures, which should not be taken as a limitation to the scope of the invention in any way, and where:

FIGS. 1-2 show an exemplary embodiment where a container is being diverted from a main conveyor and directed to one of three directions, one being the same as the initial direction, and optionally the container can be vertically transported to a second level. FIG. 1 is essentially a blow-up view of the region circled (200) in FIG. 2.

FIGS. 3A and B show a close-up view of an exemplary hinged divert section and its operation. In FIG. 3A the first transport elements, belts (110) in this case, can contact an article on the surface of the hinged divert section to move it. In FIG. 3B, the belts (110) will not contact the article and only rollers (120), a second transport element, can contact and move the article in a different direction relative to the movement possible from the belts. Each of the transport elements here, the belts (110) and rollers (120), allow movement of an article on the hinged divert section in different directions or onto different conveying surfaces after the article is moved from the hinged divert section.

FIGS. 4A, B, and C show a side view of the same embodiment of FIG. 3. In FIG. 4A the belts (110) can be seen as able to contact an article on the divert section and the belts (110) are positioned so as to avoid contact between the lower surface of the article (not shown) and the rollers (shown in the cut-away view of FIG. 4C) that are tilted below the article in FIG. 4A. In FIG. 4B, the belts (110) cannot be seen and cannot contact the lower surface of the article. In FIG. 4C, part of the housing is removed so that the motorized piston (151) can be seen in contact with a tray (122) that moves up and down and is linked to the transport elements. FIG. 4C shows that cut-away view of the position in FIG. 4B, where rollers (120) can contact lower surface of article and belts (110) cannot. Piston (151) in FIG. 4C is in up position to lift tray (122) assembly with connected rollers.

FIGS. 5A and B show another embodiment, where the article can be moved in any of four directions off of the divert section. Again, belts and rollers can be used as transport elements.

FIGS. 6 shows an alternative embodiment, where an additional set of transport elements, short belts (180), are positioned at a desired angle, which is not perpendicular or 180 degrees, from the direction of the main or first conveyor, which is defined by the belts (110). In this particular embodiment, the raised and lowered tray positions cause either or both of belts (180) and rollers (120) to engage an article on the hinged divert section. Once the tray (122) is raised by a piston, for example, the article can rest on both belts (180) and rollers (120), and either belts (180) or rollers (120) can be activated in order to move the article in a desired direction.

FIG. 7 depicts yet another embodiment where the each side of the hinged divert section represents a separate tray that can be activated or moved into a raised position by a piston, for example. FIGS. 8A and B depict additional views and embodiments of the tray

elements in connection with the frame of the hinged divert section. FIG. 8A shows a cut-away section of the frame (125) so that tray (154) is visible. This tray (154) can be fixed to the frame or moveable in relation to the frame, or moveable in relation to a second tray, not shown here. FIG. 8B shows the fixed connection points (155) of motorized units (160) to tray or frame. Thus, the trays can support transport elements in the belts (110) or rollers (not shown here).

### DETAILED DESCRIPTION OF EXEMPLARY EMBODIMENTS

As mentioned above, the invention comprises several different systems that can incorporate a conveying operation, apparatus or method. In a general aspect of a particularly preferred embodiment, the hinged divert sections comprise a tray holding at least one transport element to move an article from the surface of the hinged divert section in one of several directions, and preferably perpendicular to the main conveyor path. The main conveyor path can be defined by the direction of articles moving onto the hinged divert section and continuing over the hinged divert section in the same direction by a second transport element. During a divert or transfer stroke, the transport element(s) held by or connected to the tray engage the article from below the surface of the conveyor. These transport element(s) can be activated at any desired time point in the process. By employing a hinge or pivot point(s) with the tray holding the transport element(s), the force required to lift the full weight of the article can be substantially reduced in order to move the article from the divert section. The design and operation advantageously reduces the energy or force required to divert an article. In preferred embodiments, the articles being conveyed have a maximum weight between about 70 to about 250 pounds, or can have a minimum weight of about 20 pounds or 50 or more pounds. In one aspect, the invention is used to convey U.S. Postal system containers and fulfills any requirements of conveying containers of that size and weight. In other aspects, the invention can be used in conveying articles into and out or a storage system, as in retail or other merchandise.

In one aspect, the invention provides an improvement in the use of the transferring or diverting operation in a conveying system. In another aspect the invention comprises a new multi-directional, hinged divert section, which can be employed to transfer articles in an improved manner. The transport elements of the hinged divert section will generally include motorized rollers (120) or belts (110) that can move the article in the conveyor. The use of either belts or rollers is optional, however, and various combinations of rollers, belts, pushers, or moving apparatus can be selected or combined to replace those shown in the Figures. Other methods or motorized surfaces, apparatus, or devices can be used in place of rollers and belts in this and any other aspect of the invention. Motors, drives, and other actuating devices can be combined with the transport element assembly in order to make the divert action respond to a master control computer at a certain time point or at a certain signal.

A controller can also be used to maintain motor speed of the rollers or belts of the conveying surfaces or the hinged divert section. Different speeds may be desired at different point in the conveying and diverting processes. As in other examples of the art, rollers can be operably linked with belts or chains, and vice versa, and set at a tension to control the movement on the conveying surfaces. The force required to lift the hinged section while an article is resting on the hinged divert section can also be monitored or recorded using available devices, such as force monitors in the piston lifting the tray of the hinged section. In this way, the weight of the article or the contents of a container can be measured or recorded.

A controlling device (123) or bumper can also be used to assist in stopping a tray in a known, repeatable area on the divert section so that an article or container can be diverted accurately. One of skill in the art is familiar with computer control methods for detecting the point at which an article is located on the conveyor, as well as other mechanical methods, such as stop devices, to accurately locate an article. The control logic to be used is known to one of skill in the art and can be selected from any available.

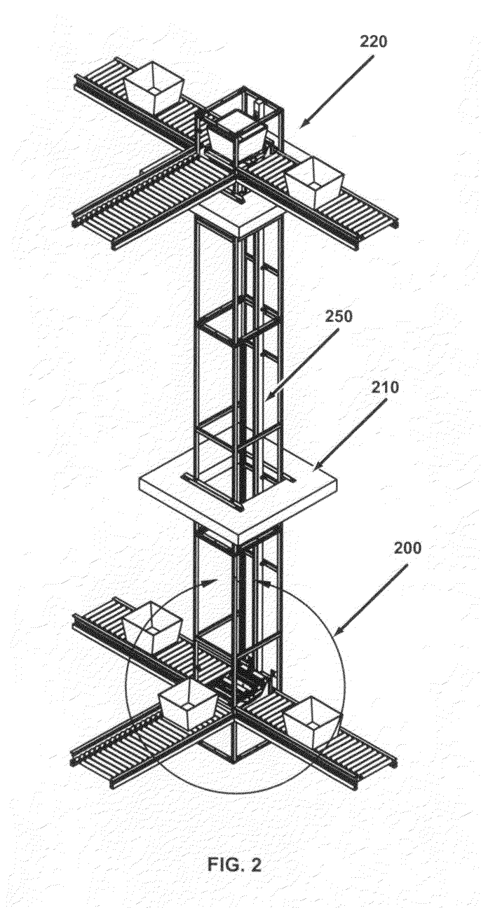

Referring specifically now to the drawings, FIG. 2 shows a conveying system with multiple vertical levels. A top level (220) and a bottom level (200) each contain a hinged divert section at the center of the conveying surfaces that emanate from it. The hinged divert section can move along a vertical guide (250) from one level to another at the command of a control system. Level (210) represents an additional vertical point where the hinged divert section can be linked to more conveyors, but the conveyors are not shown here.

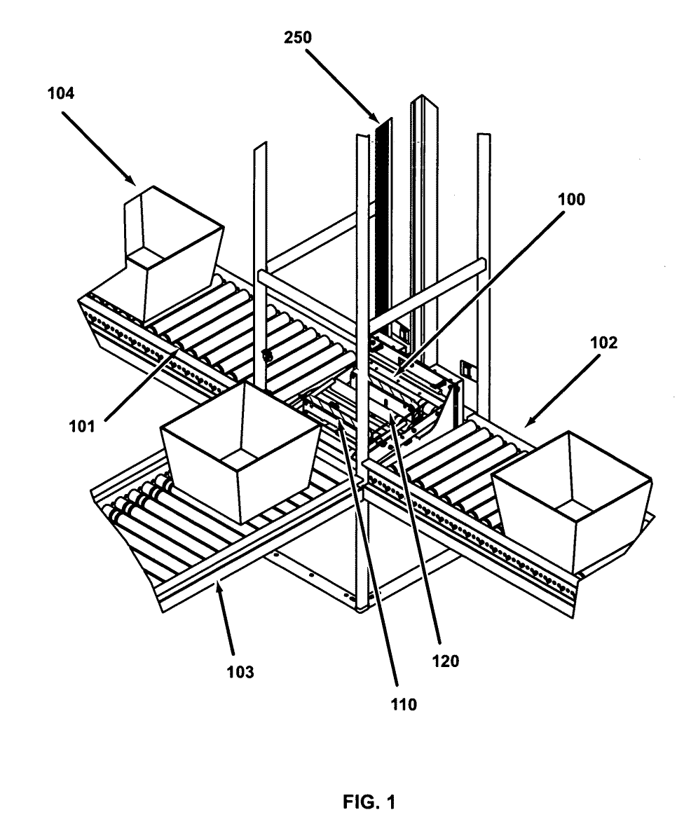

FIG. 1 shows a close-up view of the region (200) circled in FIG. 2. Multiple containers/articles (104) are shown in each of the possible divert directions for this arrangement and their respective conveying surfaces (101) (102) and (103) and their directions on this vertical level. The hinged divert section (100) is at the center of these conveying surfaces.

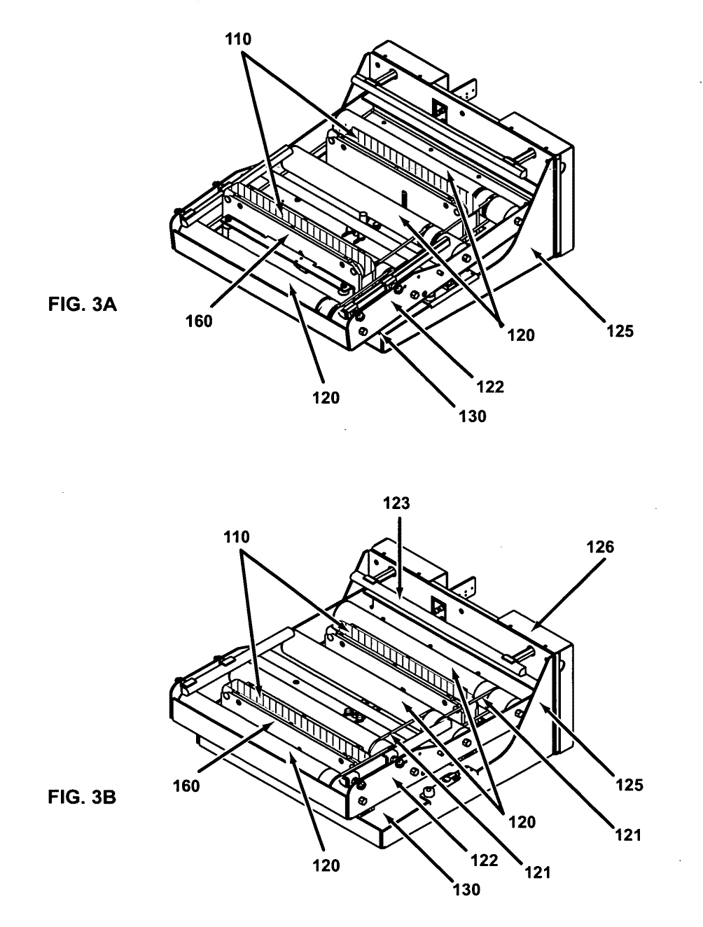

FIGS. 3 A and B show the operation of the hinged divert section in a tray lowered (3A) and tray raised (3B) configurations. In FIG. 3A, tray (122) holding transport rollers (120) is in a lowered configuration so that at point (130) the tray contacts or nearly contacts the lower housing. The housing (125) includes a region here that effectively blocks the diverting action in one of the four possible perpendicular directions. In FIG. 3B, the tray (122) is raised and the point (130) exhibits a larger distance from the housing to the tray. Belts (110) are used to divert or convey an article in one of two directions using motorized units (160) below, as the direction of the belts (110) can be controlled. Rollers (120) activated by roller drive belts (121) move the article in a third possible direction. The entire hinged divert section can be vertically moved by a connection in area (126) to a vertical guide and drive, as shown in FIG. 2. The actual hinge point for tray (122) is located behind housing (125), consistent with the movement of the tray (122) shown in comparing FIG. 3A with FIG. 3B.

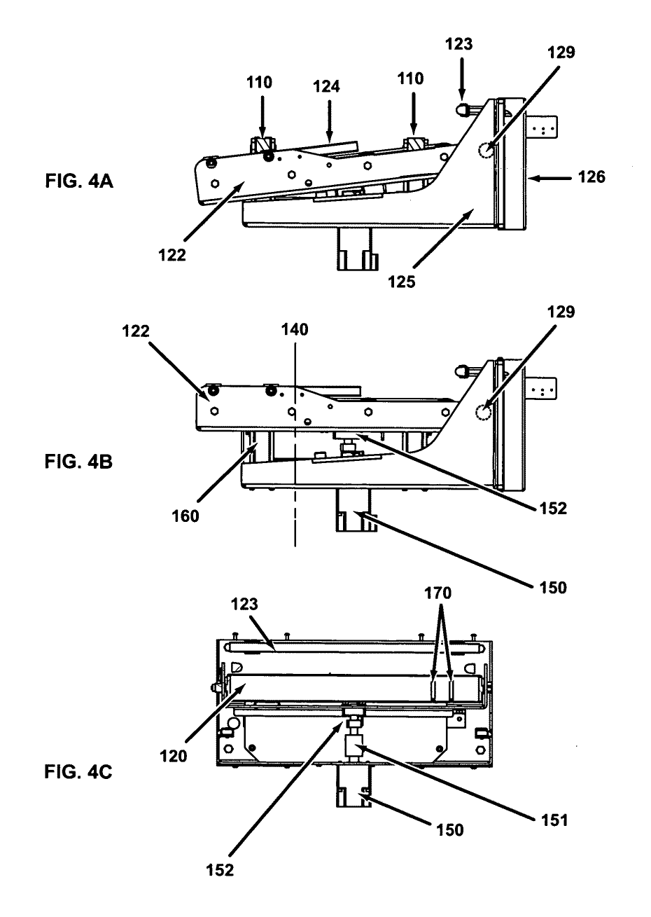

FIGS. 4A and B show a side view of the same embodiment of a hinged divert section in FIGS. 3A and B. In FIG. 4A, the moving surface of belts (110) can be seen at a position where the tray (122) is lowered and an article would be moved in one of two directions by the action of the belt motors (160) driving the belts (110). An optional guide (123) or bumper maintains the article in a desired position, and guide (123) can be moved by motor or piston into various positions in order to re-position an article. A separate optional guide (124) is also shown on the side of the tray (122). FIG. 4B shows a contact point (152) of a pushing motor or piston assembly (150) on the underside of the tray (122). Again, the comparison of views in FIG. 4A and B exemplify a hinge or pivot point for the tray (122) on frame or housing (125) here shown as dotted point (129) in FIGS. 4A and B.

FIG. 4C shows the piston assembly (150) with piston (151) and contact point with tray (152) to lower and raise tray as shown in FIGS. 4A and B. One roller (120) with grooves (170) for roller drive belts (121) (not shown) can be seen.

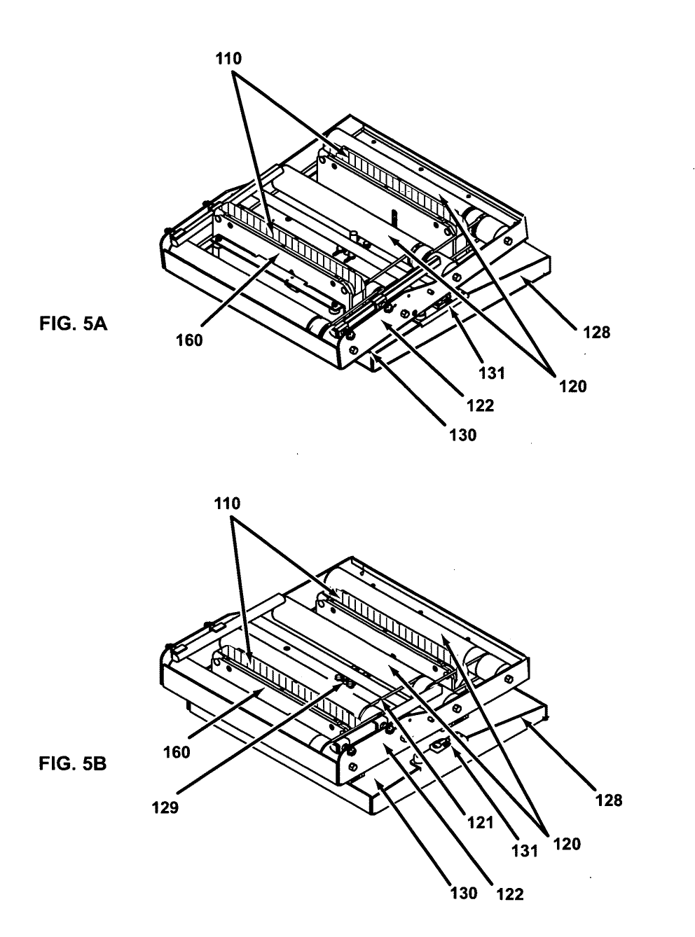

FIGS. 5A and B show another embodiment where four possible divert directions exist. Tray (122) can pivot down to side (128) as in FIG. 5A or down to side (130) so that an article can move in one of two directions by the action of the belts (110) in FIG. 5A. Tilting at pivot point (131) allows one of the rollers (120) to move an article in two directions, toward side (128) or side (130) once tray (122) is pivoted or moved up into a position so that article contacts one or more rollers (120) but not belts (110). Additionally or alternatively, a piston can be used below tray (122), is in the earlier example, in order to lift tray (122) and allow rollers (120) to engage article on divert section. A connection point to a vertical guide or drive system can be made, for example below the housing or frame, but is not shown here.

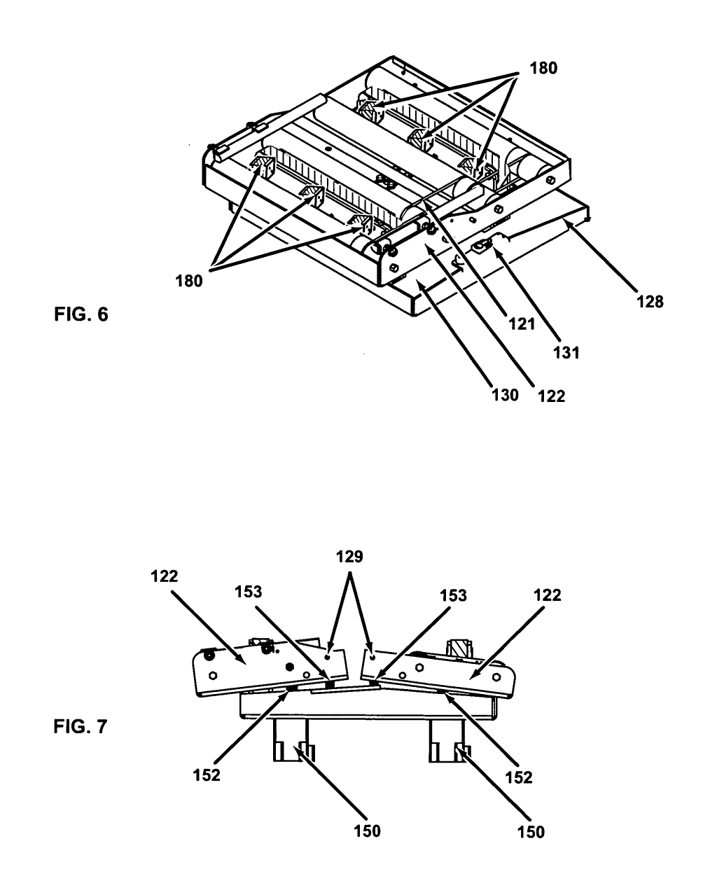

FIG. 6 shows an embodiment where one of the transport elements associated with the hinged divert section is at a non-perpendicular angle to the main conveyor direction. As shown in FIG. 6, the belts on top of transport elements (180) direct an article on the surface of the divert section into one of two non-perpendicular directions depending on the direction the belts are driven.

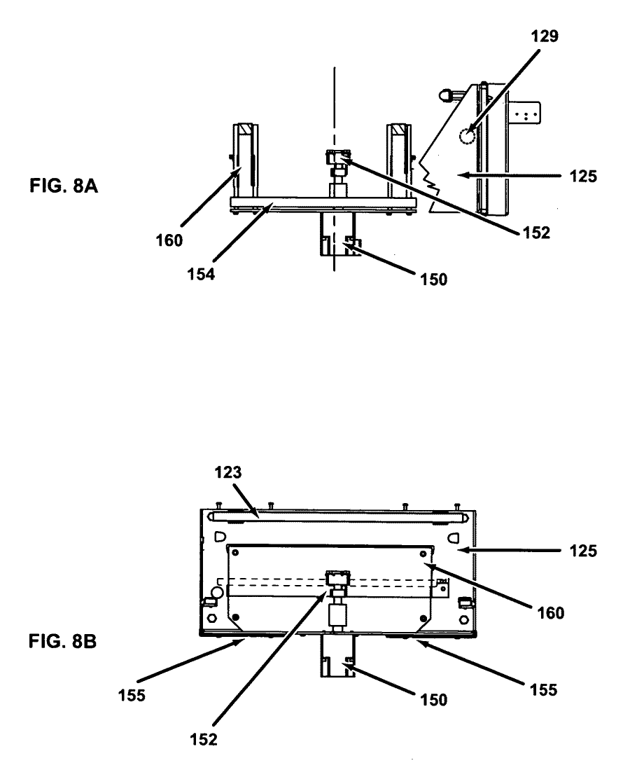

FIG. 7 shows an embodiment where two separate trays (122), left and right, are positioned at each side of the divert section frame. The pivot points for each are shown at (129). Each tray is associated with a separate piston unit (150) and connection point (152). The pivot point (129) is part of support member (153) connected to the frame.

FIGS. 8A and B show cutaway views of the trays in relation to the frame. In FIG. 8A, a separate tray (154) supporting transport element motorized units (160) can be seen behind frame (125). This separate tray can be moveable and associated with its own piston or device to move it into different positions relative to the surface upon which an article would rest or move. In FIG. 8A, the tray (122) supporting rollers (120), as shown in FIGS. 4A-C, is not shown. In FIG. 8B, the frame (125) forms the support for the connection of motorized units (160) at point (155). The tray configurations shown in FIGS. 8A-B are not exclusive to those possible, and the transport elements supported by a tray can be moved into position by means other than a piston, such as a sliding tray that moves into an up or down position with respect to contacting the article on the divert section when sliding, or a tray incorporating a folding arm or arms that allows the transport element to move down when folded and back up to engage the article when extended. The devices available to implement these options on moveable trays are known to those of skill in the art.

Throughout this disclosure, applicants may refer to texts and other sources of information. One skilled in the art can use the entire contents of any of the cited sources of information to make and use aspects of this invention. Each and every cited source of information is specifically incorporated herein by reference in its entirety. Portions of these sources may be included in this document as allowed or required. However, the meaning of any term or phrase specifically defined or explained in this disclosure shall not be modified by the content of any of the sources. The description and examples are merely exemplary of the scope of this invention and content of this disclosure and do not limit the scope of the invention. In fact, one skilled in the art can devise and construct numerous modifications to the examples listed below without departing from the scope of this invention.

What is claimed is:

1. A conveying system comprising:
a first conveyor having a first conveying surface along which an article may be conveyed in a first direction;
a second conveyor having a second conveying surface along which an article may be conveyed in a second direction; and
a hinged divert section operably connected to the first conveyor and the second conveyor, the hinged divert section comprising:
a frame;
a first transport element oriented to allow movement of an article along the direction of the first conveying surface;
a second transport element oriented to allow movement of an article along the direction of the second conveying surface; and
a tray supporting the first transport element, the tray being pivotally connected to the frame such that the tray is movable between a first position, wherein an article on the first conveying surface contacts only the first transport element, and a second position, wherein an article on the first conveying surface contacts only the second transport element.

2. The conveying system of claim 1, wherein the first and second transport elements are motorized belt or roller systems.

3. The conveying system of claim 1, wherein the second direction is substantially perpendicular to the first direction.

4. The conveying system of claim 1, wherein the tray is moveable between the first position and the second position by the action of a motorized piston contacting the tray.

5. The conveying system of claim 1, wherein the tray is moveable between the first position and the second position by the action of a fluidic or pneumatic driven piston contacting the tray.

6. The conveying system of claim 1, wherein the system further comprises a vertical transport element for movement of the hinged divert section from a first vertical level to a second vertical level, and wherein the second transport level can operably be connected to the second vertical level.

7. The conveying system of claim 6, further comprising a third vertical level.

8. The conveying system of claim 4, wherein the system is designed and configured to convey containers of at least 20 pounds in total weight, and the piston can cause the movement of the tray upward with a container of 250 pounds.

9. The conveying system of claim 1, wherein the tray supporting the first transport element is pivotally connected to the frame to reduce the effective force required to lift the tray, so that an article contacts only the first transport element, is reduced by at least 20% compared to the force required to lift the article by a vertical piston alone.

10. A conveying system comprising:
a first conveyor having a first conveying surface;
a second conveyor having a second conveying surface; and
a divert section operably connected to the first conveyor and the second conveyor, the divert section comprising:
a first tray supporting a first transport element; and
a second tray supporting a second transport element,
wherein the first tray and the second tray are movable relative to each other between a first configuration, wherein an article moving through the conveying system contacts only the first transport element at a desired time and is thereby conveyed along the first conveying surface, and a second configuration, wherein an article moving through the conveying system contacts only the second transport element at a desired time and is conveyed along the second conveying surface.

11. The conveying system of claim 10, wherein the first and second tray are moveable relative to each other by a hinged connection of the first or second tray to a stationary frame element of the divert section.

12. The conveying system of claim 10, wherein the second transport element is a motorized belt or roller system.

13. The conveying system of claim 10, wherein the second conveying surface is oriented in a direction substantially perpendicular to the first conveying surface.

14. The conveying system of claim 10, wherein the first or second tray is moveable between a first position and a second position by the action of a motorized piston.

15. The conveying system of claim 10, wherein the first or second tray is moveable between a first position and a second position by the action of a fluidic or pneumatic driven piston contacting the tray

16. The conveying system of claim 10, wherein the system further comprises a vertical transport element for movement of the divert section from a first vertical level to a second vertical level, and wherein one of the first and second transport surfaces is operably be connected to the second vertical level.

17. A method for conveying an article comprising providing a conveying system with at least one conveying path operably connected with at least one multi-directional hinged divert section and having second and optionally third or more conveying paths also operably connected to the divert section, conveying an article onto the surface of the divert section, controlling the movement of one or more transport elements on the multi-directional hinged divert section in order to move the article in a desired direction corresponding to one of the conveying paths connected to the divert section, wherein the movement of the one or more transport elements is confined by a pivot point on a frame element of the divert section.

18. The method of claim 17, further comprising transferring the divert section while an article is on it surface to a second vertical level of conveying path or paths.

19. The method of claim 17, wherein the movement of the one or more transport elements by a pivot point on a frame further comprises weighing the article while the movement of one or more transport elements on the multi-directional hinged divert section is performed.

20. The method of claim 17, further comprising detecting the position of the article on the multi-directional hinged divert section with a camera or opto-electronic device.
